(19) United States
(12) Patent Application Publication
(10) Pub. No.: US 2007/0101358 A1
(43) Pub. Date: May 3, 2007

(54) Method and system of authenticating host

(75) Inventor: Balagopalan Ambady, Broomfield, CO (US)

Correspondence Address: BROOKS KUSHMAN P.C., 1000 TOWN CENTER, TWENTY-SECOND FLOOR, SOUTHFIELD, MI, 48075, US

(73) Assignee: Cable Television Laboratories, Inc., Louisville, CO (US)

(21) Appl. No.: 11/264,721

(22) Filed: Nov. 1, 2005

(51) Int. Cl. H04N 7/167

(52) U.S. Cl. 725/31; 380/210

(57) ABSTRACT

A method of authenticating a host used to unscramble scrambled television signals. The method including authenticating the host in response to receiving a correct reply to a question and answer (Q&A) inquiry, wherein the Q&A inquiry includes a question and answer.

### BACKGROUND OF THE INVENTION

1. Field of the Invention

The present invention relates to methods and systems of authenticating a host.

2. Background Art

A host may be used in any number of environments to support cryptographic operations. One common host relates to a feature used to decrypted encrypted television signals. The host may be an application, settop box (STB), and/or some other feature associated with a television or other output device that includes capabilities for descrambling the scrambled television signals for playback on the output device.

With respect to cable, internet, and satellite television, a relatively large number of hosts are required to support a similarly large number of users. Government deregulation has forced television providers to support descrambling on generic hosts so as to permit manufacturing competition with respect to host production. As such, the television providers have had to develop strategies for authenticating the generic hosts to descramble proprietary scrambling techniques of the various television providers.

One solution employed by the television providers is a CableCard. The CableCard is a plug-in-play type device that may be inserted into the host to decrypt the encrypted signals. The CableCards are typically used for authenticating a host with a headend or other network element associated with the television provider, such as by checking the host's credentials against a trust anchor (Root Certificate Authority) stored on the CableCard, and then delivering an unlocking key to the CableCard to unlock (descramble) the encrypted television signals.

The CableCard-Host authentication process requires both the Host and the CableCard to be issued digital certificates from under the same trusted CA, and the serial number or other identification associated with both the CableCard and the host are to be provided to the television provider at the time of activation by user. This authentication process increases the cost to the user (as the host requires a CableCard slot and associated mechanisms), as well as to the operator (cost of headend support for CableCards, cost of CableCard and certificates) In addition, current generation of CableCards do not support revocation checking of the host at the time of binding (i.e. if a host is considered trusted or not).

### SUMMARY OF THE INVENTION

One non-limiting aspect of the present invention relates to a method of authenticating a host used to unscramble scrambled television signals. The method may include generating a question in response to receipt of an authentication request requesting authentication of the host, encrypting the question, receiving an answer in response to the host decrypting the question, and authenticating the host as a function of whether the answer is a correct reply to the question.

The method may include associating the host with public and private host keys, wherein the method further comprises encrypting the question with the public host key and decrypting the question with the private host key.

The method may include transporting an unlocking key from a network element to the host for use by the host in decrypting the encrypted television signals after successful authentication.

The method may include signing the encrypted question with a private network element key associated with the network element, wherein the method further includes the host verifying the signed encrypted message with a public network element key associated with the network element and then decrypting the encrypted question with the private host key so as to secure transportation of the encrypted question from the network element to the host.

The method may include hashing the answer with a hashing algorithm prior to encrypting the answer such that the host determines the answer by decrypting and hashing the question with the hashing algorithm.

The method may include transporting the question to the host through signals communicated through a network used to communicate the television signals thereto and/or configuring the host to receive the question from user inputs thereto, such as from a remote control associated therewith.

The method may include displaying the answer to a user associated with the host such that the user provides the answer in response to the display thereof, such as by receiving the user response through non-television communications.

The method may include randomly generating the answer such that the question is randomly generated.

One non-limiting aspect of the present invention relates to a method of authenticating a host used to unscramble scrambled television signals. The method may include authenticating the host in response to receiving a correct reply to a question and answer (Q&A) inquiry, wherein the Q&A inquiry includes a question and answer. Optionally, the answer may be received through non-television signaling.

The method may include receiving the question through television or non-television signaling.

The method may include controlling the host to automatically generate the answer from the question.

One non-limiting aspect of the present invention relates to a system for use in authenticating a host used to unscramble scrambled signals. The system may include a network element configured for generating a question in response to receipt of an authentication request requesting authentication of the host, an answer algorithm for use by the host in automatically generating an answer to the question, and an unlocking key for use by the host in descrambling the scrambled signals, the unlocking key being provided to the host in response to the answer being the correct answer to the question.

The network element may generate the question by encrypting the answer using a public host key such that determining the answer to the question requires the host to decrypt the question with a private host key.

The network element may transport the question to the host through signals communicated through a network used to communicate the television signals thereto. Alternatively, the host may determine the question from user inputs thereto, such as from inputs received from a remote control

The host may display the answer to a user associated with the host such that the user provides the answer in response to the display thereof.

One non-limiting aspect of the present invention relates to a host for use in descrambling scrambled television signals. The host may include an algorithm for automatically generating an answer from a question and an input feature for facilitating inputting of the question to the host.

The host may include an output feature for outputting the answer to the question, such as by displaying the answer to a user associated therewith and/or communicating the answer to a remotely located network element for determining whether the answer is a correct answer to the question.

The host may be configured to receive an unlocking key from a remotely located network element in response to the answer being a correct answer to the question.

The above features and advantages, along with other features and advantages of the present invention, are readily apparent from the following detailed description of the invention when taken in connection with the accompanying drawings.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for authenticating a host in accordance with one non-limiting aspect of the present invention; and

FIG. 2 illustrates a flowchart of a method for authenticating the host in accordance with one non-limiting aspect of the present invention.

### DETAILED DESCRIPTION OF THE PREFERRED EMBODIMENT(S)

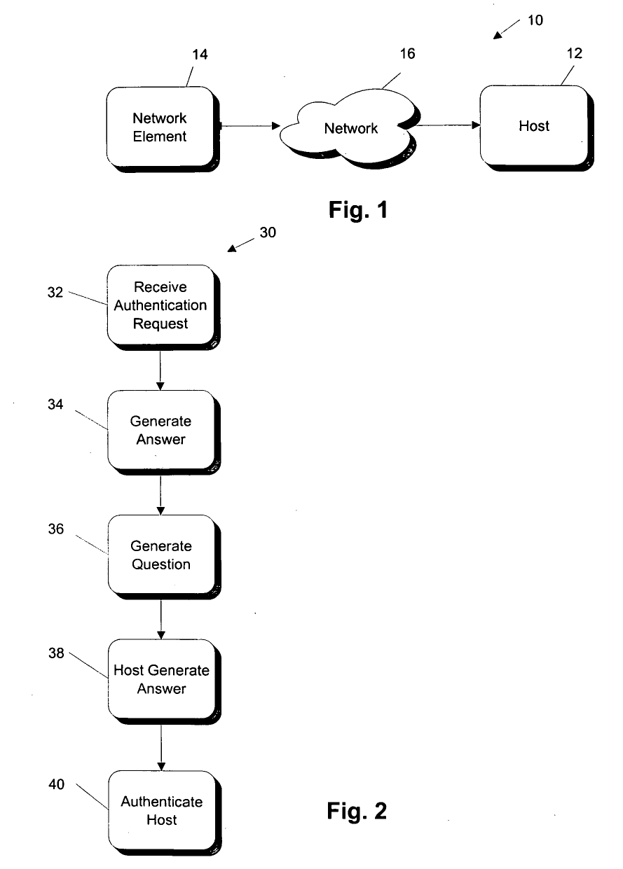

FIG. 1 illustrates a system 10 for authenticating a host 12 in accordance with one non-limiting aspect of the present invention. A network element 14 may be included to facilitate authenticating the host 12 and a network 16 may be included to facilitating communications with the host 12. The system 10 may be associated with any number of environments and applications wherein a host may be used to descramble scrambled signals.

The system 10, for exemplary purposes, is described with respect to the host 12 being configured to descramble scrambled television signals, such as for output to an output device (not shown), like a television, computer, mobile device, or other similar feature having means for displaying television images. The present invention is not, however, intended to be so limited and fully contemplates authenticating a host for any number of applications, and not just for decrypting television signals.

The host 12 may be any feature, application, device, and/or other logically executing unit, or some integration thereof, having capabilities for facilitating descrambling of the scrambled television signals, either directly and/or with the assistance of other items. Optionally, the host may be a settop box (STB), outlet digital adapter (ODA), media terminal adapter (MTA), cable modem (CM), personal digital assistant (PDA), computer, mobile device (phone, computer, etc.), integrated television feature/application, and any other item having capabilities to supporting access to any number of services, including television services associated with the encrypted television signals.

Optionally, the host 12 may be configured to descramble and to support and/or facilitate the use of any number of television and non-television related signals, such as, but not limited to, Hyper Text Transfer Protocol (HTTP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (OOB) messaging, and others.

Likewise, the host 12 may be configured to descramble and to support and/or facilitate the use of any number of television and non-television services and applications, such as, but not limited to, linear and non-linear television programming (cable, satellite, broadcast, etc.), Video on Demand (VOD), interactive television (iTV), interactive gaming, pay-per-view (PPV), digital video recording (local and remote), and others. (A one-way communicable host may be unable to perform some of these functions.)

The network 16 may be configured to include any number of devices, features, and options to support signal communications between a service provider (not shown), network element and/or host. The network 16 may include terrestrial and extraterrestrial components and infrastructures. It may include cable lines, telephone lines, and/or satellite or other wireless architectures. The network 16 may be associated with other private and/or public networks, such as the Internet and provider specific private networks.

For example, one or more of the network support features may be a router, hub, switch, gateway, conditional access router (CARs), cable modem terminations system (CMTSs), network provisioning unit (NPUs), session boarder controller, media gateway, media gateway controller, signaling gateway, call management server, presence server, SIP routing proxy, SIP proxy/registrar server, PCMM policy server, bandwidth on demand server, streaming server caching proxy, gaming server, CDN, media acquisition server, provider server, a unified messaging server, OSS/BSS, global directory server, digital or personal video recorder (DVRs, PVRs), media terminal adapter (MTA), and/or outlet digital adapter (ODA).

FIG. 2 illustrates a flowchart 30 of a method for authenticating the host 12 in accordance with one non-limiting aspect of the present invention. The method may be embodied and executed according to instructions or other executable logic included within a computer-readable medium associated with the network element 14 and/or some other feature associated with the system 10. The method may be used to authenticate the host 12 to support any number of operations, and for exemplary purposes, is described with respect to authenticating the host 12 to descramble scrambled television signals (cable, internet, satellite, etc.).

Block 32 relates to determining or otherwise receiving an authentication request requesting authentication of the host 12. The request may be received electronically by the network element 14, such as through messaging received from the host 12, and/or by an operator or integrated voice recording (IVR) feature associated with a television service provider (not shown), such as through a phone call, email, or other message from a user associated with the host 12. Optionally, the host 12 of the present invention may be a relatively low cost feature having limited communication capabilities such that it may not have capabilities to execute two-way communications, i.e., it may be unable to communicate upstream to the network element 14 or other remotely located features, requiring the user to call the MSO in order to request authentication.

The authentication request may include a host identifier or other feature for identifying the host 12 associated therewith. The identifier may be compared to a whitelist, database, or other feature associated with the television service provider to determine whether the host 12 is suitable for authentication. For example, the service provider, as a threshold, may only permit authentication of previously identified hosts 12, such as to prevent unauthorized authentication. The whitelist may be kept for verifying the host identifier, such as through a automatic cross-reference or operator search. The whitelist may also be periodically updated to add new hosts, or to remove hosts that are no longer suitable for authentication.

Optionally, as described below in more detail, the whitelist may be used to facilitate associating private and public host keys with each host 12 listed therein. The keys may be cryptographic keys suitable for securing communications with the host 12, such as keys associated with the Ron Rivest, Adi Shamir and Len Adleman (RSA) method. In general, the public key may be used to encrypt messages and other signals that can only be decrypted, at least practically, with the corresponding private key. The private key may be locally stored on the host 12 and/or protected in some other fashion to limit access thereto.

Block 34 relates to generating an answer for use in authenticating the host 12. The answer may correspond with any number of variables and parameters, such as a random number generated by the network element, such as 1245. (More values may be used to enhance security.) The random number generation can be used for generating different answer for each authentication request so as to limit access thereto. The answer may be used as a part of a question and answer (Q&A) inquiry to test authentication of the host 12.

Block 36 relates to generating a question for the answer. The question may be determined by encrypting or otherwise disguising the answer. For example, the host's public key may be used to encrypt the random number (1245) into a fixed or non-fixed length variable (5689) such that the answer may only be recovered by decrypting the question with the host's private key, which optionally only the host 12 possesses. In addition, an optional hashing algorithm maybe applied to the generated question before being encrypted in order to make use of larger numbers (to increase security) and for ease of use for the user/operator. The host 12 may include the same hashing algorithm to unearth the answer thereto. The hashing algorithm may be embedded on the host, such as during production, and/or otherwise securely transmitted thereto.

Block 38 relates the host generating an answer or other reply to the question. This may include the host 12 having an answer algorithm to facilitate automatically generating the answer from the questions, which as described in the following, may include decrypting and/or hashing the question. This may include providing the question to the host 12 for decryption with the host private key in order to determine the associated answer, and optionally thereafter, controlling the host 12 to apply the same hashing algorithm to the decrypted result. The question may be encrypted and transported to the host 12 from the network element 14, such as through television signaling (including in-band or out-of-band (OOB) messaging) and/or through some other means.

Optionally, the question may be provided to the host 12 without such television signaling, such as by prompting a user thereof to input the question to the host 12. For example, if the answer is a random number (1245), the question, resulting from the encrypting thereof, may be a numerical variable (5689) that may be inputted to the host 12 with a remote control or other user interface associated with the operation thereof. The user may contact the network element 14, and/or an operator associated therewith having access to the question and answer, to receive the question. For example, the user may contact the network element 14 through non-television signaling, such as with a phone call (wireless, cellular, VoIP, public switching telephone (PST), etc.).

Regardless of whether the question is communicated to the host 12 through the television signaling and/or non-television signaling, the host 12 may be configured to output its decryption and hashing of the question on the television or other output device associated therewith. The output may be a simply screen display identifying the answer and the values associated therewith. For example, the screen display may simply state the numbers “1245” (which is the answer determined after decrypting and optionally hashing the question (“5689”)) with further instructions to contact the service provider (MSO) associated therewith. This may be advantageous for use with hosts 12 having limited communication capabilities, such as hosts 12 having only one-way communication capabilities wherein the host 12 is unable to communicate upstream to the service provider.

The screen display, and optional prompt to contact the MSO, allows the user to review the answer and receive instructions for further action. The user may then contact the MSO through a phone call, message, or other interface to notify the MSO of the answer thereto. Optionally, with such one-way limited hosts 12, some form of non-television signaling may be required to communicate the reply to the MSO. For example, a non-fee phone number may be provided for the user to call an operator and/or IVR. The operator and/or IVR may prompt the user to input the answer for verification. If the user's answer matches with the answer generated in block, then the host 12 may be verified for authentication.

Block 40 relates to authenticating the host 12. This generally includes verifying whether the host/user has provided a correct reply to the Q&A inquiry, i.e., the answer generated by the host 12 matches the answer used to form the question, and communicating an unlocking key or other feature to the host 12 to facilitate unscrambling of the scrambled television signals. The system may be used with any number of television signal providers, and therefore, configured to support authenticating hosts 12 and delivering keys and other features for any number of different cryptographic systems and methods.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of authenticating a host used to unscramble scrambled television signals, the method comprising:
generating a question in response to receipt of an authentication request requesting authentication of the host;
encrypting the question;
receiving an answer in response to the host decrypting the question; and
authenticating the host as a function of whether the answer is a correct reply to the question.

2. The method of claim 1 further comprising associating the host with public and private host keys, wherein the method further comprises encrypting the question with the public host key and decrypting the question with the private host key.

3. The method of claim 2 further comprising configuring a network element to facilitate authenticating the host, the network element being configured to generate and encrypt the question.

4. The method of claim 3 transporting an unlocking key from the network element to the host for use by the host in decrypting the encrypted television signals after successful authentication.

5. The method of claim 3 further comprising signing the encrypted question with a private network element key associated with the network element, wherein the method further comprises the host verifying the signed encrypted message with a public network element key associated with the network element and then decrypting the encrypted question with the private host key so as to secure transportation of the encrypted question from the network element to the host.

6. The method of claim 1 further comprising hashing the answer with a hashing algorithm prior to encrypting the answer such that the host determines the answer by decrypting and hashing the question with the hashing algorithm.

7. The method of claim 1 further comprising transporting the question to the host through signals communicated through a network used to communicate the television signals thereto.

8. The method of claim 7 further comprising configuring the host to receive the question from user inputs thereto.

9. The method of claim 8 further comprising configured the host to determine the user inputs from signals received from a remote control associated therewith.

10. The method of claim 1 further comprising displaying the answer to a user associated with the host such that the user provides the answer in response to the display thereof.

11. The method of claim 10 further comprising receiving the user response through non-television communications.

12. The method of claim 1 further comprising randomly generating the answer such that the question is randomly generated.

13. A method of authenticating a host used to unscramble scrambled television signals, the method comprising:
authenticating the host in response to receiving a correct reply to a question and answer (Q&A) inquiry, wherein the Q&A inquiry includes a question and answer, the answer being received through non-television signaling.

14. The method of claim 13 further comprising receiving the question through television signaling.

15. The method of claim 13 further comprising receiving the question through non-television signaling.

16. The method of claim 13 further comprising receiving the answer through signaling carried over a public telephone switching network (PSTN), a wireless telephone network, or a Voice Over Internet Protocol (VoIP) network.

17. The method of claim 13 further comprising controlling the host to automatically generate the answer from the question.

18. A system for use in authenticating a host used to unscramble scrambled signals, the system comprising:
a network element configured for generating a question in response to receipt of an authentication request requesting authentication of the host; an answer algorithm for use by the host in automatically generating an answer to the question; and
an unlocking key for use by the host in descrambling the scrambled signals, the unlocking key being provided to the host in response to the answer being the correct answer to the question.

19. The system of claim 18 wherein the network element generates the question by encrypting the answer using a public host key such that determining the answer to the question requires the host to decrypt the question with a private host key.

20. The system of claim 19 wherein the network element transports the question to the host through signals communicated through a network used to communicate the television signals thereto.

21. The system of claim 18 wherein the host determines the question from user inputs thereto.

22. The system of claim 18 wherein the host displays the answer to a user associated with the host such that the user provides the answer in response to the display thereof.

23. A host for use in descrambling scrambled television signals, the host comprising:
an algorithm for automatically generating an answer from a question; and
an input feature for facilitating inputting of the question to the host.

24. The host of claim 23 further comprising an output feature for outputting the answer to the question.

25. The host of claim 24 wherein the output feature is configured to facilitate displaying the answer to a user associated therewith.

26. The host of claim 24 wherein the output feature is configured to facilitate communicating the answer to a remotely located network element for determining whether the answer is a correct answer to the question.

27. The host of claim 23 configured to receive an unlocking key from a remotely located network element in response to the answer being a correct answer to the question.

28. The host of claim 23 configured to hash the question prior to generating the answer thereto.

29. The host of claim 23 wherein the input feature is configured to receive the question through inputs received from a local user.
